(19) United States
(12) Patent Application Publication
(10) Pub. No.: US 2009/0075548 A1
(43) Pub. Date: Mar. 19, 2009

(54) MANUFACTURING METHOD FOR CROSS-WIRING ELECTRODE WIRE OF FIELD EMISSION DISPLAY

(76) Inventors: Shih-Chien Hsiao, Guanyin Township (TW); Pu-Hsin Chang, Guanyin Township (TW)

Correspondence Address: HDLS Patent & Trademark Services, P.O. BOX 220746, CHANTILLY, VA, 20153-0746, US

(21) Appl. No.: 11/856,779

(22) Filed: Sep. 18, 2007

(51) Int. Cl. H01J 9/24

(52) U.S. Cl. 445/24

(57) ABSTRACT

A manufacturing method of cross-wiring an electrode wire of a field emission display is used for forming a cross-wire structure of an electrode wire. In the method, a has a conducting layer, and the conducting layer has a protruded object. A tool is used for aligning the substrate, and the tool has a dispensing pillar made of an elastic material. The front end of the dispensing pillar has a dispensing head aligning precisely with the position of the protruded object. After a conductive adhesive is adhered onto the dispensing head, the protruded object is pressed, such that the dispensing head is deformed to cover the protruded object completely, and the conductive adhesive adhered on the dispensing head forms a conducting layer on the outer circumferential surface of the protruded object for cross-wiring an electrode wire, immediately after the dispensing pillar is pulled away.

### BACKGROUND OF THE INVENTION

1. Field of the Invention

The present invention generally relates to a field emission display, and more particularly to a manufacturing method of an electrode wire on a substrate.

2. Description of Prior Art

In recent years, a field emission display (FED) not only maintains the original thin and lightweight advantages of a flat panel display, but also has higher resolution and brightness than other types of flat panel displays, and the internal electron emission source is made of a nano material, and thus the field emission flat display has made a great leap forward in its development.

To cope with the scope of applicability and different sizes of the field emission flat displays, the length and layout of electrode wires inside the field emission flat displays will become very complicated, and thus the design of electrode wires within a limited vacuum space generally adopts a cross wire method, and a conductive wire is wired across another conductive wire or a barrier rib at the same position of a protruded object on a substrate, so as to shorten the path required for the layout of each electrode wire.

In general, the methods for forming electrode wires of this sort include evaporation, printing and press printing, but the cost of evaporation is too high and thus evaporation is not applicable for the manufacture of low-end products, or will lower the product competitiveness. Therefore, printing and press printing methods become better alternatives for the manufacture of low-end products. Regardless of the printing method or the press printing method, drawbacks still exist in a three-dimensional cross-wire structure of the conductive wires. In the prior art as shown in FIG. 1A, a protruded object 101 installed on a substrate 10 of a field emission display generally has a height up to 50 μm˜250 μm, and thus it generally adopts the silk screen printing method for laying a conducting layer 102. However, the tools for the silk screen printing method are usually made of hard materials, and thus the tools cannot accommodate dead corners produced by the height difference between the protruded object 101 and the substrate 10 as shown in FIG. 1B, and broken lines of the conducting layer 102 mat result at the height difference between the protruded object 101 and the substrate 10, and a normal cross-wire structure cannot be formed easily.

The conventional press printing method as shown in FIGS. 2A to 2C employs a tool 20 having a plurality of dispensing pillars 201 for sticking a conductive adhesive 30 to press and print directly onto a protruded object 101 of the substrate 10, so that the conductive adhesive 30 forms a conducting layer 102 on the protruded object 101 as a cross-wire conductive wire structure. Since the conventional dispensing pillar 201 is made of a hard material, the dispensing pillar 201 can only touch the front side of the protruded object 101 when it is pressed and printed onto the protruded object 101, the lateral sides of the protruded object 101 cannot be pressed and printed easily, and the glue of the conductive adhesive 30 flows naturally to cover the lateral sides of the protruded object 101 only to form a conducting layer 102. In FIG. 2B, the conductive adhesive 30 is used for the natural flow effect, but it will cause a uniform thickness of the conducting layer 102 or even a too-thin conducting layer 102 on the lateral sides of the protruded object 101. If a too-thin conducting layer 102 on the lateral sides of the protruded object 101 is sintered, the conducting layer 102 may have the aforementioned broken lines easily. If the condition is improved by increasing the quantity of conductive adhesive 30, excessive conductive adhesive 30 may be accumulated on both lateral sides of the protruded object 101 as shown in FIG. 2C and the glue may be too thick and cannot be condensed after the sintering process, and thus affecting the life of the vacuum area inside the field emission display. Obviously, the aforementioned prior art methods require further improvements.

In view of the shortcomings of the prior art, the inventor of the present invention provides a reasonable and feasible design in accordance with the present invention to overcome the foregoing shortcomings.

### SUMMARY OF THE INVENTION

It is a primary objective of the present invention to provide a manufacturing method of cross-wiring an electrode wire of a field emission display, and the method is provided for wiring a conductive wire across an obstructed object, and using a gluing tool and a press printing process to produce a deformation to cover a protruded object of a substrate, and further forming a conductive wire completely covered onto the protruded object to assure the integrity and the electric conduction of the cross-wire structure.

To achieve the foregoing objective, the present invention provides a manufacturing method of cross-wiring an electrode wire of a field emission display, wherein a substrate is provided, and the substrate has a conducting layer, an a protruded object is disposed on the conducting layer, and a tool is provided for aligning the substrate, and the tool has a dispensing pillar made of an elastic material, and the front end of the dispensing pillar has a dispensing head precisely aligned with the position of the protruded object, so that after a conductive adhesive is adhered onto the dispensing head, the protruded object is pressed down vertically, and the material of the dispensing head is deformed to wrap around the protruded object, and the conductive adhesive adhered on the dispensing head forms a conducting layer on the outer circumferential surface of the protruded object for cross-wiring an electrode wire, immediately after the dispensing pillar is pulled away.

### BRIEF DESCRIPTION OF DRAWINGS

FIGS. 1A and 1B are section views of a conventional silk screen printing operation;

FIGS. 2A to 2C are section views of a convention press printing operation;

FIG. 3 is a section view of an operating structure in accordance with the present invention;

FIG. 4 is an exploded view of an operation in accordance with the present invention;

FIGS. 5A and 5B are schematic section view of sticking an adhesive in accordance with the present invention;

FIGS. 6A and 6B are schematic section views of a press printing operation in accordance with the present invention;

FIG. 7 is a section view of an operation in accordance with the present invention.

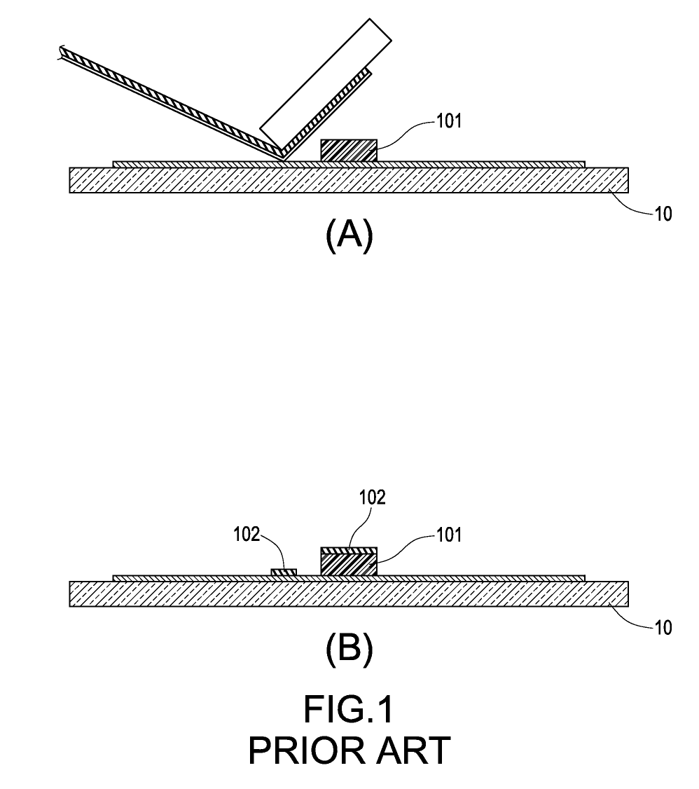

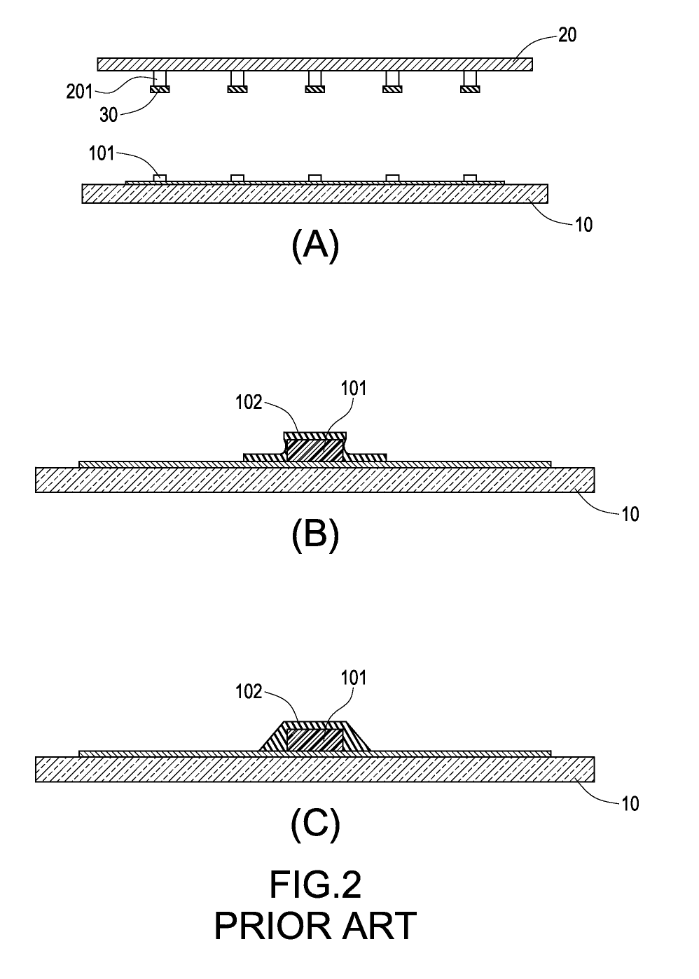

### DETAILED DESCRIPTION OF THE INVENTION

The technical characteristics, features and advantages of the present invention will become apparent in the following detailed description of the preferred embodiments with reference to the accompanying drawings. The drawings are provided for reference and illustration only, but not intended for limiting the present invention.

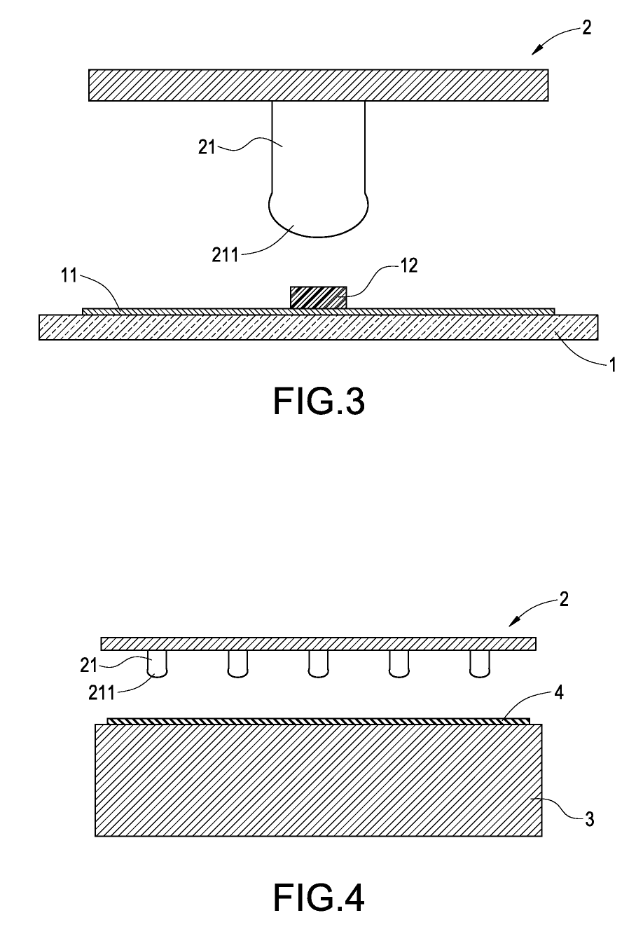

Referring to FIG. 3 for a section view of an operating structure in accordance with the present invention, the operating structure of the invention comprises a substrate 1, and the substrate 1 has a conducting layer 11, and the conducting layer 11 has a protruded object 12 disposed thereon, wherein the protruded object 12 is a support member for providing a support effect or a barrier wall for providing a packaging and isolation effect. In this embodiment, the support member is used for illustration purpose only. The operating structure further comprises a tool 2 for aligning the substrate 1 to dispense an adhesive onto the substrate 1, wherein the tool 2 has a dispensing pillar 21 made of a deformable material such as rubber, and the dispensing pillar 21 has a dispensing head 211 substantially in a convex shape, and the dispensing head 211 of this embodiment is in a hemispherical shape, for adhering and printing a conductive adhesive onto the substrate 1.

Refer to FIGS. 4 to 7 for schematic views and exploded views of the operations of the present invention.

In FIG. 4, a tool 2 having a dispensing pillar 21 is provided, and then a dispensing platform 3 is provided, and a layer of conductive adhesive 4 is coated onto the dispensing platform 3, wherein the thickness of the conductive adhesive 4 after being scraped at the platform is equal to or greater than 100 μm.

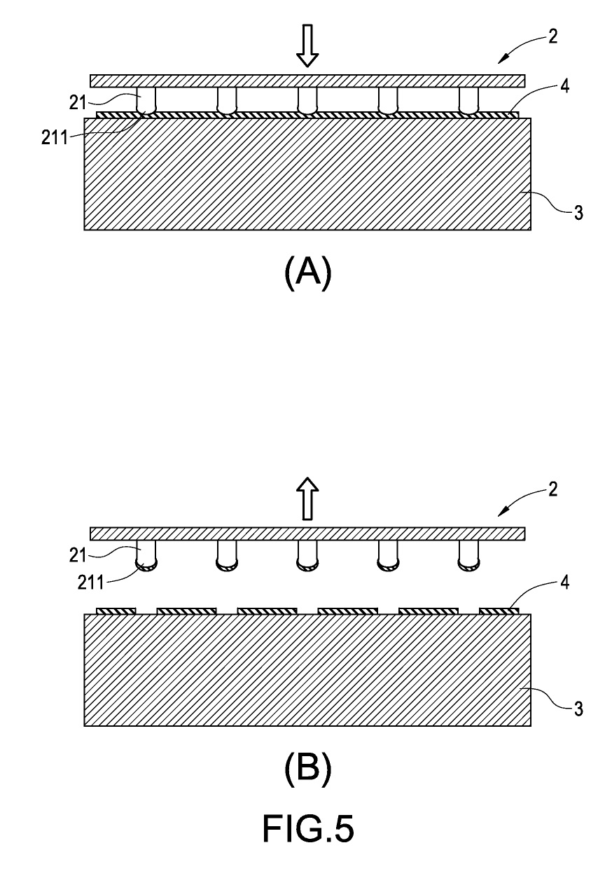

In FIGS. 5A and 5B, the tool 2 aligns with the position of the dispensing platform 3, and the tool presses onto the dispensing platform 3, and the dispensing pillar 21 of the tool 2 sticks the conductive adhesive 4 onto the dispensing head 211. After the conductive adhesive 4 is adhered onto the tool 2, the tool 2 is lifted up from the dispensing platform 4, and the conductive adhesive 4 is centralized at the central position of the dispensing head 211 due to the gravitational force, so that the thickness of the conductive adhesive 4 adhered to the central position of the dispensing head 211 is greater than the thickness adhered to the periphery of the dispensing head 211 (as shown in the figures).

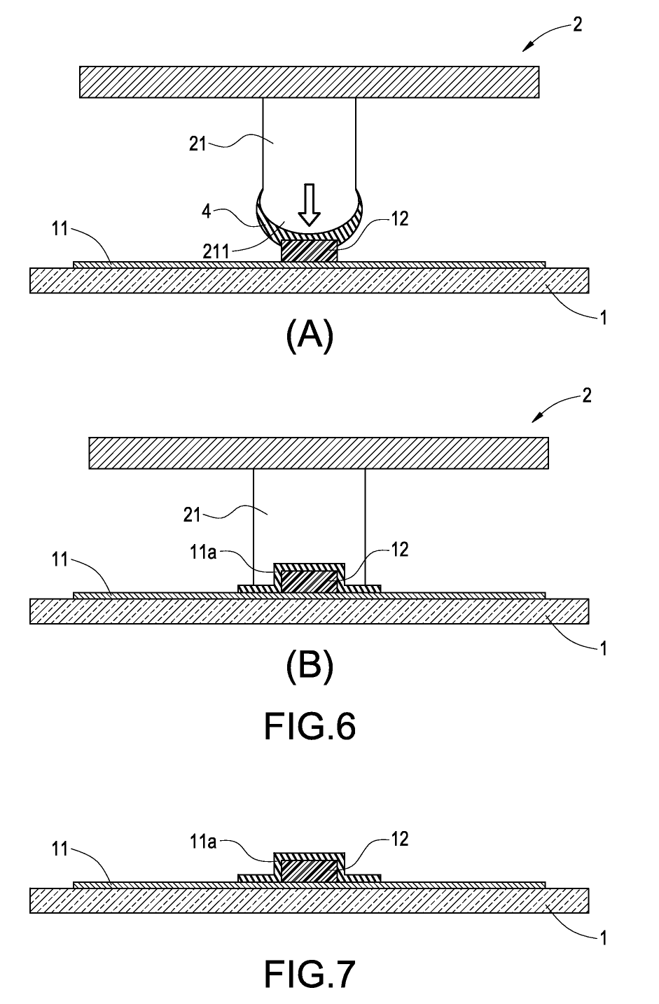

Referring to FIGS. 6A and 6B, the tool 2 adhered with the conductive adhesive 4 is aligned with the substrate 1, and the dispensing pillar 21 of the tool 2 is aligned precisely with the position of the protruded object 12 on the substrate 1, and the dispensing pillar 21 of the tool 2 is pressed and printed vertically on the protruded object 12 of the substrate 1, such that after the dispensing pillar 21 is pressed for printing, the elastic material of the dispensing pillar 21 is deformed, and the dispensing head 211 of the dispensing pillar 21 covers an external surface of the protruded object 12 completely. After the tool 2 is pressed and printed onto the substrate 1, the tool 2 is lifted, and the conductive adhesive 4 adhered onto the dispensing head 211 is stuck uniformly onto the external periphery of the protruded object 12 to form a conducting layer 11a across the protruded object 12 as shown in FIG. 7, so that the conducting layer 11a is electrically coupled with the conducting layer 11 on the substrate 1 to complete the cross-wire structure of the electrode wire.

The present invention is illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A manufacturing method of cross-wiring an electrode wire of a field emission display, the method wiring a conductive wire of a protruded object across a substrate having a protruded object, and the method comprising the steps of:
(a) sticking a dispensing head with a conductive adhesive;
(b) pressing and printing the dispensing head adhered with the conductive adhesive onto the protruded object;
(c) deforming the dispensing head to cover the protruded object; and
(d) lifting a tool such that the conductive adhesive covers the protruded object.

2. The manufacturing method of cross-wiring an electrode wire of a field emission display as recited in claim 1, further comprising a step of providing a dispensing platform for retaining the conductive adhesive and sticking the conductive adhesive to the tool.

3. The manufacturing method of cross-wiring an electrode wire of a field emission display as recited in claim 2, wherein the conductive adhesive of the dispensing platform is scraped to a thickness equal to or greater than 100 μm.

4. The manufacturing method of cross-wiring an electrode wire of a field emission display as recited in claim 1, wherein the dispensing head is made of a deformable material.

5. The manufacturing method of cross-wiring an electrode wire of a field emission display as recited in claim 1, wherein the dispensing head is made of a rubber material.
